(19) United States
(12) Patent Application Publication
(10) Pub. No.: US 2015/0283487 A1
(43) Pub. Date: Oct. 8, 2015

(54) FILTER MATERIAL WITH LONG SERVICE LIFE AND FILTER ELEMENT CONTAINING SAID FILTER MATERIAL

(71) Applicant: NEENAH GESSNER GMBH, Bruckmühl (DE)

(72) Inventors: Andreas Demmel, Feldkirchen-Westerham (DE); Christof Keppler, Vagen (DE); Christoph Haeringer, Muenchen (DE)

(73) Assignee: NEENAH GESSNER GMBH, Bruckmuehl (DE)

(21) Appl. No.: 14/438,461

(22) PCT Filed: Oct. 17, 2013
(86) PCT No.: PCT/EP2013/071715

§ 371 Date: Apr. 24, 2015

(30) Foreign Application Priority Data
Oct. 24, 2012 (DE) 102012219409.6

(51) Int. Cl. B01D 39/14

(52) U.S. Cl. CPC B01D 39/14

(57) ABSTRACT

The invention relates to a filter material in particular for filtering liquids. The filter material is impregnated with a binder on only one side such that the opposite side is free of the binder and the content of the dried binder is 0.5 to 50 wt. % of the total weight of the filter material. Using the filter material according to the invention, a high degree of separation is achieved while maintaining a long service life. The invention further relates to a filter element which comprises the filter material according to the invention. Further aspects of the invention relate to the use of the filter material according to the invention in order to filter liquids and to a method for separating two non-mixable liquids, said liquids being conducted through the filter material according to the invention.

The invention relates to a filter material with improved service life for separating liquid and solid impurities from liquids, a filter element comprising this filter material, the use of the filter material for filtering liquids and a method for separating two non-mixable liquids.

### PRIOR ART

In many areas of filtration, the requirements regarding the degree of purity of filtered liquids are becoming more strict. This applies both to industrially used liquids, such as for example fuels for internal combustion engines, lubricating oils or hydraulic oils, as well as to liquids in the field of foodstuffs, and medical or pharmaceutical applications. For example, in the filtration of diesel fuels for internal combustion engines, the requirement regarding the separation efficiency according to ISO 19438 for particles having a size of 4 μm has increased from 50% to 96% over the past 15 years and will be above 99% in the future. Thus, major efforts have been undertaken in the past in order to continuously increase the separation efficiency of the filter materials used. Unfortunately, the separation efficiency and the service life in most cases run counter to each other, which means that the dust storage capacity and thus the service life deteriorate with an increasing separation efficiency and vice versa. One possibility of maintaining the service life and thus the lifetime of a filter element with an increasing separation efficiency at at least the same level is to increase the filter surface. However, this necessarily increases the entire filter element and is undesired in many cases for reasons of space.

Another possibility of improving the service life of high-performance filter media is the use of a prefilter ply. The prefilter ply is located on the inflow side of the filter material, and it has considerably larger pores than the high-performance filter ply. DE 10 2010 011 512 A1, for example, describes such a gradient filter. The higher the requirements regarding a high separation efficiency with a simultaneously long service life, the more coordinated filter plies are necessary in order to meet these requirements. However, each additional ply increases the thickness and the costs of the entire filter material.

Impregnated filter materials provide the possibility of increasing the service life with a consistent thickness by impregnating the filter material on only one side. On the non-impregnated side, the fibers are not bonded with an impregnating agent, and therefore they maintain their open pore structure, whereas the pores on the impregnated side are reduced in size by the impregnating agent. Thus, a gradient is formed over the thickness of the filter material, which combines a long service life and a high separation efficiency, with the liquid always flowing against the non-impregnated side. With a suitable selection of the fibers used and the impregnating agent, the filter material impregnated on one side can additionally be used for separating two non-mixable liquids. An example of such a liquid mixture is a fuel contaminated with water. The water therein is the disperse phase and the fuel is the continuous phase. If the finely distributed water droplets impact hydrophilic, non-impregnated fibers, they are retained there. Continuously new water droplets unite with the water droplets on the fibers and form droplets increasing over the course of time, which finally become detached by the hydrostatic pressure and which are pressed through the impregnated, hydrophobic side of the filter material. On the clean side, the water droplets, due to their greater density and the gravitational force, flow downwards along the impregnated surface of the filter material, and are collected in a collection chamber and separated. By this effect, the water separation principle changes from a water separator on the dirt side to a coalescer medium.

U.S. Pat. No. 3,096,230 A describes a filter paper impregnated on one side, in which the impregnating agent penetrates the paper up to approximately one third of the paper thickness. The entire paper is pre-impregnated with a thermally curable resin.

U.S. Pat. No. 3,106,528 A discloses a filter paper which is impregnated on only one side, but in which the impregnating agent penetrates the entire paper thickness. By selecting the suitable viscosity of the impregnating agent and the pressure with which the impregnating agent is pressed into the paper, it is achieved that most of the impregnating agent remains on the impregnated side and only little impregnating agent penetrates the opposite side.

In U.S. Pat. No. 3,116,245 A, a filter paper of 100% cotton linters is disclosed, which is impregnated twice. First of all, a resin is applied to both sides, and afterwards the filter paper is impregnated with a different resin on one side up to half of its thickness. The impregnation is carried out in such a manner that the pore size does not change significantly over the entire thickness. Accordingly, this filter paper does not have a binder-free side.

U.S. Pat. No. 4,119,543 A describes a filter material of at least 70% cellulose, which is impregnated on one side. With this filter material, the impregnation is applied in the form of a pattern. This pattern contains surfaces with impregnating agent and surfaces which are free of impregnating agents.

There is a need for a filter material for in particular filtering liquids, which meets the stricter requirements regarding high separation efficiencies and long service lives and which can be used at the same time for separating non-mixable liquids.

### SUMMARY OF THE INVENTION

According to the invention, this object is solved by a filter material which is suitable in particular for filtering liquids and which is impregnated with a binder on only one side such that the opposite side is free of binder, with the proportion of the dried binder being 0.5 to 50 wt. % of the total weight of the filter material.

### DETAILED DESCRIPTION OF THE INVENTION

The filter material according to the invention preferably comprises at least one material selected from the group consisting of wet-laid nonwovens, dry-laid nonwovens, fabrics and foams.

Dry-laid nonwovens are to be understood to be, inter alia, dry-laid fibrous nonwovens, meltblown nonwovens and spunbonded nonwovens.

Dry-laid fibrous nonwovens consist of fibers having a finite length. Both natural and synthetic fibers can be used for the production of dry-laid fibrous nonwovens. Examples of natural fibers are cellulose, wool, cotton and flax. Synthetic fibers are, for example, polyolefin fibers, polyester fibers, polyamide fibers, polytetrafluoroethylene fibers and polyphenylene sulfide fibers. The fibers used can be either straight or crimped. The dry-laid staple fiber nonwovens can also be air-laid fibrous nonwovens. For solidification, the dry-laid fibrous nonwoven can contain one-component or multicomponent melt-bonding fibers which melt down in their entirety or in part at a temperature below the melting temperature of the other fibers and which solidify the nonwoven. The production of the dry-laid fibrous nonwovens is carried out in accordance with the known prior art, such as is described in the book “Vliesstoffe” by W. Albrecht, H. Fuchs, W. Kittelmann, Wiley-VCH, 2000. The dry-laid fibrous nonwovens can be solidified by the one-component or multicomponent melt-bonding fibers already mentioned above. Further solidification possibilities are, for example, needling, water-jet needling or the soaking or spraying of the nonwoven with liquid binders with subsequent drying.

Meltblown nonwovens consist of polymeric filaments. For the production of meltblown nonwovens for the filter material according to the invention, the meltblown process known among experts is used, as is described, for example, in Van A. Wente, “Superfine Thermoplastic Fibers”, Industrial Engineering Chemistry, vol. 48, pages 1342 to 1346. Suitable polymers are, for example, polyethylene terephtalate, polybutylene terephtalate, polyethylene naphtalate, polybutylene naphtalate, polyamide, polyphenylene sulfide and polyolefines. The typical fiber diameters are preferably between 0.5 and 10 μm and particularly preferably between 0.5 and 3 μm. Depending on the requirements, additives, such as for example hydrophilizing agents, water-repellent agents, crystallization accelerators or dyes, can be mixed with the polymers. Depending on the requirement, the surface of the meltblown nonwovens can be changed in its property by surface treatment processes, such as for example corona treatment or plasma treatment. Moreover, the meltblown nonwovens can be compressed by means of a calender, if necessary.

Spunbonded nonwovens also consist of polymeric filaments, the fiber diameters of which are, however, in most cases considerably larger than those of meltblown fibers. Spunbonded nonwovens are produced in accordance with the spunbonded nonwoven process known among experts, as is described, for example, in the patent specifications U.S. Pat. No. 4,340,563 A, U.S. Pat. No. 3,802,817 A, U.S. Pat. No. 3,855,046 A and U.S. Pat. No. 3,692,618 A. Polymers suitable for the spunbonded nonwoven process are, for example, polyethylene terephtalate, polybutylene terephtalate, polyethylene naphtalate, polybutylene naphtalate, polyamide, polyphenylene sulfide and polyolefines.

Foams are to be understood to be all open-cell foams of organic polymers. Due to their open-cell structure, they are air-permeable and suitable for various filtration tasks. The production of suitable foams is described, for example, in the specifications U.S. Pat. No. 3,171,820 A, DE 1504551 A, DE 601435 A and GB 1111928 A.

Wet-laid nonwovens or papers within the meaning of this invention are all nonwovens which can be generated by means of the wet-laying processes for producing filter papers, which are known among experts. The papers for the filter material according to the invention preferably consist of natural, synthetic, inorganic fibers or a mixture thereof. Examples of natural fibers are cellulose, cotton, wool and hemp, and the used cellulose material can be wood-free and/or wood-containing celluloses of conifers and/or broad-leaved trees, regenerated celluloses and fibrillated celluloses. Inorganic fibers are, for example, glass fibers, basalt fibers, quartz fibers and metal fibers. Polyester fibers, polypropylene fibers, multicomponent fibers with different melting points of the individual components, polyamide fibers and polyacrylonitrile fibers are suitable as synthetic fibers, for example. The titer of the synthetic fibers is typically 0.1 dtex to 8.0 dtex, particularly preferably 0.5 dtex to 5 dtex, and the length of cut is typically 3 mm to 20 mm, particularly preferably 4 mm to 12 mm. The papers for the filter material according to the invention can consist at 100% of natural, synthetic or inorganic fibers, but any mixture of these fiber types is also possible. Due to his knowledge and experience, the person skilled in the art knows how to specifically select the right composition depending on the required paper properties. The paper ply can consist of plural layers which are generated and brought together either in a paper machine with a headbox suitable therefor or can consist of individual paper webs which are connected to each other in a separate working step. The properties of the individual layers can be configured differently.

Filter materials for filtering liquids are usually impregnated with a binder. The binder is applied to the filter material by impregnation, and it penetrates at least a part of the filter material. The impregnated surface of the filter material remains permeable in particular for liquids. The impregnation provides the filter material with a high stiffness and resistance against aggressive liquids, such as for example hot engine oils, hydraulic oils, fuels, acids and lyes. Since most of the filter materials are folded in a further processing step, a high stiffness is necessary. Stiff filter materials are easier to fold, and the folds resist the filtration pressure even at high flow rates and temperatures.

The filter materials are usually fully impregnated with the binder in a soaking bath, for example, and subsequently dried. The full impregnation has the advantage that all fibers are fixedly connected to each other and enveloped with the binder. Thereby, the fibers and thus also the filter material are protected against the attack of aggressive liquids. The optimal stiffness can be achieved by selecting the suitable binder.

However, binders also reduce the size of the pores in the filter material by filling the interstices between the individual fibers. By this, the separation efficiency is improved, but the air permeability and in particular the service life and thus the lifetime of the filter material are decreased at the same time. In the filter material according to the invention, only one side is impregnated with the binder such that the opposite side is free of binder. This one side can be impregnated in part, for example with patterns having arbitrary geometric shapes, such as, for example, dots, straight lines, curved lines, crossing lines, rectangles, rhombuses and triangles, or throughout, which means over the entire surface, and it is preferably impregnated throughout. The impregnated side is understood to be the part of the filter material which is limited by the surface of the filter material to which the binder is applied. The opposite side designates the part of the filter paper which is limited by a surface that is opposite the surface of the impregnated side and does not contain a binder. The filter material according to the invention is preferably extensive (i.e. taking up a broad but not thick surface), which means it has two opposite surfaces that are arranged particularly preferably parallel to each other. By an impregnation applied to one side, for example by roller application or spraying, the same stiffness and the same separation efficiency are achieved as with a fully impregnated filter material, however the service life is considerably longer and corresponds to a non-impregnated filter material. To achieve this effect, the liquid must flow against the non-impregnated side of the filter material impregnated on one side.

The grammage (weight per unit area) of the filter material according to the invention is preferably 50 g/m² to 400 g/m² and particularly preferably 100 g/m² to 300 g/m². The thickness of the filter material according to the invention is preferably 0.1 mm to 2.0 mm and particularly preferably 0.5 mm to 1.5 mm. The thickness of the filter material according to the invention relates to the distance between the surface to which the binder is applied and the opposite surface. The filter material according to the invention preferably has an air permeability of 1 l/m²s to 1500 l/m²s and particularly preferably an air permeability of 5 l/m²s to 800 l/m²s. The porosity of the filter material according to the invention is preferably 50% to 90% and particularly preferably 60% to 80%. The porosity relates to the proportion between the actual density of the filter medium and the average density of the fibers used. The filter material according to the invention preferably has a resin content of 0.5% to 50%, particularly preferably 5% to 20%. The filter material according to the invention preferably has a separation efficiency of at least 50% for 4 μm particles according to ISO 19438, particularly preferably at least 80%, and a service life according to ISO 19438 of at least 1.0 g, particularly preferably at least 1.5 g. The water separation according to ISO 19332 with an inflow of 4.5 ml/(cm²*min) in the filter material according to the invention is preferably at least 30%, particularly preferably at least 40%.

It was found that particularly suitable are filter materials impregnated on one side, which have a grammage of 50 g/m² to 400 g/m², preferably 100 g/m² to 300 g/m², a thickness of 0.1 mm to 2.0 mm, preferably 0.5 mm to 1.5 mm, an air permeability of 1 l/m²s to 1500 l/m²s, preferably 5 l/m²s to 800 l/m²s, and a porosity of 50% to 90%, preferably 60% to 80%, and a resin content of 0.5% to 50%, preferably 5% to 20%. With filter materials configured in this way, the service life according to ISO 19434 is considerably longer than with comparable fully impregnated filter materials with a meltblown nonwoven as a prefilter. This effect was not to be expected. The papers impregnated on one side according to the hitherto prior art have a considerably higher air permeability and thickness and are at best equivalent to the comparable fully impregnated filter materials with a meltblown nonwoven as a prefilter with regard to the service life and water separation.

If the filter material according to the invention is used for separating a liquid mixture of two non-mixable liquids, it is configured, due to the selection of the hydrophobia and hydrophilicity of the fibers and the impregnating agent, such that the droplets of the disperse phase of the liquid mixture are preferably collected and increased on the fibers, while the impregnation ensures an easy flow of the continuous phase and at the same time makes the flow of the droplets of the disperse phase more difficult. The fibers and the impregnation are therefore different with regard to their hydrophilicity and hydrophobia. Examples of hydrophilic fibers are cellulose fibers, cotton fibers, polyamide fibers and hydrophilically coated fibers. Hydrophobic fibers are, for example, polyolefin fibers, teflon fibers and hydrophobically coated fibers.

Non-mixable liquids are understood to be liquids which do not form a homogeneous mixture or solution, but are a two-phase mixture, such as for example oil and water. Within the meaning of the invention, two non-mixable liquids are characterized in that at room temperature (20° C.) a maximum of 10 wt. % and preferably a maximum of 1 wt. % of the one liquid are dissolved in the respective other liquid, in relation to 100 wt. % of the two non-mixable liquids.

Suitable binders are, for example, phenolic resins or epoxy resins from alcoholic solutions, but also aqueous dispersions, for example of acrylates, styrene-butadienes, polyvinyl acetates, phenolic resins or polyvinyl chloride. A further possible class of binders are aqueous solutions of polyvinyl alcohol, melamine resin or urea resin, for example. Along with the liquid binders, solid, powdery binders of thermoplastic polymers can also be used.

Depending on the requirements, various excipients can be mixed with the binder, such as, for example, hydrophilizing agents, water-repellent agents, flame retardants or dyes.

Should the filter material have a denser and a more open side, the impregnation is preferably applied to the denser side. The denser side differs from the more open side by a smaller average pore size, with the average pore size of the denser side being preferably at least 5%, more preferably at least 10%, and particularly preferably at least 20% smaller than that of the more open side.

The application of the binder is controlled, for example, by means of the viscosity of the binder solution or by means of suitable settings of the process parameters such that the binder penetrates, from the impregnated surface of the filter material to the opposite side, preferably at least half, but at the most three quarters, of its thickness, particularly preferably between two thirds and three quarters of the thickness. The opposite side remains essentially binder-free. Suitable methods of impregnation are, for example, roller application or spraying. With roller application, the process parameters, by which the penetrating depth of the binder can be controlled, are, for example, the film thickness of the binder on the application roller, the viscosity of the binder as well as the solids content of the binder. If the applicator consists of two rollers, for example a dip roller taking the binder from a storage vessel, for example a tub, and transferring it to the application roller, and an application roller applying the binder to the filter material, the suitable film thickness can be set by means of the differential speed of the two rollers and the gap between the rollers. With spraying, which means the spray application, the process parameters used for controlling the penetrating depth are, for example, the viscosity of the binder, the solids content of the binder, the diameter of the spray nozzles and the amount of binder sprayed per time unit. The aforementioned parameters as well as the precise and expedient setting thereof for achieving a particular penetrating depth of the binder are known to the person skilled in the art. The assessment of the penetrating depth of the binder into the filter material is undertaken by means of a reflected light microscope at a cross section of the filter material. The proportion of the dried binder of the total weight of the paper is 0.5 to 50 wt. %, preferably 5 to 20 wt. %. Within the meaning of the invention, the proportion of the dried binder relates to the proportion of the binder in the filter material which was dried in a circulating drier cabinet for 30 minutes at 100° C.

A preferred embodiment of the filter material according to the invention is a paper of natural fibers, synthetic fibers, inorganic fibers or mixtures thereof, which is impregnated with a binder on the wire side, which means on the denser side, such that the binder penetrates approximately two thirds of the paper thickness, with the fibers of the opposite side remaining binder-free. This filter material has the following preferred properties: a grammage of 50 g/m² to 400 g/m², particularly preferably 100 g/m² to 300 g/m²; a thickness of 0.1 mm to 2.0 mm, particularly preferably 0.5 mm to 1.5 mm; an air permeability of 1 l/m²s to 1500 l/m²s, particularly preferably 5 l/m²s to 800 l/m²s; a porosity of 50% to 90%, particularly preferably 60% to 80%; a resin content of 0.5% to 50%, particularly preferably 5% to 20%; a separation efficiency of at least 50%, particularly preferably at least 80%, for 4 μm particles according to ISO 19438; a service life of at least 1.0 g, particularly preferably at least 1.5 g, according to ISO 19438; and a water separation of at least 30%, particularly preferably at least 40%, according to ISO 19332 with an inflow of 4.5 ml/(cm²*min)

It is easily possible within the scope of the invention that the filter material according to the invention consists of plural plies or layers. Moreover, it is also possible that one or plural plies of other materials are provided in front of and/or behind the filter material according to the invention.

A further preferred embodiment of the filter material according to the invention is a combination of a paper and a meltblown nonwoven, with the meltblown nonwoven with the denser side being located on the non-impregnated side of the paper. The paper consists of natural fibers, synthetic fibers, inorganic fibers or mixtures thereof and is impregnated with a binder on the wire side, which means on the denser side, such that the binder penetrates approximately two thirds of the paper thickness, with the fibers of the opposite side remaining binder-free. The paper can have the following properties: a grammage of 50 g/m² to 400 g/m², preferably 100 g/m² to 300 g/m²; a thickness of 0.1 mm to 2.0 mm, preferably 0.5 mm to 1.5 mm; an air permeability of 1 l/m²s to 1500 l/m²s, preferably 5 l/m²s to 800 l/m²s; a porosity of 50% to 90%, preferably 60% to 80%; and a resin content of 0.5% to 50%, preferably 5% to 20%. The meltblown nonwoven can have a grammage of 10 g/m² to 200 g/m², preferably 20 g/m² to 120 g/m²; a thickness of 0.05 mm to 1.5 mm, preferably 0.1 mm to 1.0 mm; and an air permeability of 5 l/m²s to 4000 l/m²s, preferably 100 l/m²s to 500 l/m²s. The entire filter material of this embodiment comprising a paper and a meltblown nonwoven has preferably the following properties: a grammage of 60 g/m² to 600 g/m², particularly preferably 120 g/m² to 420 g/m²; a thickness of 0.15 mm to 3.5 mm, particularly preferably 0.6 mm to 2.5 mm; an air permeability of 1 l/m²s to 1100 l/m²s, particularly preferably 5 l/m²s to 300 l/m²s; a resin content of 5% to 50%, particularly preferably 5% to 20%; a separation efficiency of at least 50%, particularly preferably at least 80%, according to ISO 19438 for 4 μm particles; and a service life of at least 1.0 g, particularly preferably at least 1.5 g, according to ISO 19438.

The individual plies of the filter material according to the invention can be connected either by means of an adhesive or by means of weld bondings or by means of a combination thereof.

Advantageous adhesives have a softening point above 200° C. The filter material according to the invention is preferably suitable for use at temperatures of up to 150° C. and high hydrostatic pressures. Suitable adhesives for this application are polyurethane adhesives, polyamide adhesives or polyester adhesives. Particularly preferred are polyurethane adhesives which cross-link with humidity. The adhesives can be applied by means of engraved rollers or spray nozzles either as a powder or when melted down. The application weight of the adhesive is typically between 5 and 20 g/m², preferably between 5 and 10 g/m².

Weld bonding can be carried out both by means of an ultrasonic system and by means of a thermal calender. The polymers of the plies to be welded are melted down and welded either over their entire surfaces or in some areas. The weld bondings in some areas can have arbitrary geometric shapes, such as, for example, dots, straight lines, curved lines, rhombuses and triangles. The surface of the weld bondings in some areas is advantageously at the most 10% of the entire surface of the filter material according to the invention.

Adhering and welding can also be combined freely.

The filter material according to the invention can be used for filtering liquids, with the liquid flowing against the filter material from the non-impregnated side, which means the liquid is conducted from the non-impregnated side to the impregnated side through the filter material. The liquid can contain a solid material not soluble therein. Preferably, the liquid contains two non-mixable liquids.

In the method according to the invention for separating two non-mixable liquids, the liquids are conducted through the filter material according to the invention such that the liquids flow from the non-impregnated side to the impregnated side of the filter material.

### Testing Methods

Grammage according to DIN EN ISO 536

Thickness according to DIN EN ISO 534

Air permeability according to DIN EN ISO 9237 at a pressure difference of 200 Pa

Initial separation efficiency of 4 μm particles and dust storage capacity according to ISO 19438 with a specimen surface of 200 cm², an inflow concentration of 100 mg/1 and a volume flow of 0.71 l/min. End of test with an increase in differential pressure of 0.7 bar.

Water separation according to ISO 16332 with the test conditions according to Table 1, measured on flat specimens with a surface of 225 cm². The specimen is clamped such that the liquid flows against it perpendicular to its surface.

TABLE 1

| | |
|---|---|
| Measuring temperature | 23° C. ± 2° C. |
| Measuring fluid | Conventional diesel fuel |
| | with a surface tension of |
| | 15 mN/m ± 3 mN/m |
| Pressure difference between the two | 0.26 bar |
| apertures | |
| Volume flow | 1100 ml/min |
| Inflow | 4.5 ml/cm²min |
| Water addition to the diesel fuel | 1500 ppm ± 170 ppm |
| Medium droplet size | 60 μm |

The porosity is calculated on the basis of the actual density of the filter medium and the average density of the fibers used according to the following formula:

Porosity=(1−density of filter medium [g/cm³]/density of fibers [g/cm³])*100

The proportion of the impregnating agent in a paper is calculated using the following formula:

Proportion of impregnating agent in %=(FM impregnating agent/FM paper)*100%

with FM impregnating agent=mass of the dried impregnating agent per m² paper and FM paper=grammage of the impregnated paper,
with the paper being dried in a circulating drier cabinet for 30 minutes at 100° C. before determining the proportion of impregnating agent.

### EXAMPLES

### Example 1

### Comparative Example

According to the generally known method for paper manufacturing, a paper web of 100% cellulose was generated in a paper machine. In a separate working step, this paper was fully impregnated in its entirety with a methanolic phenolic resin solution and dried. The paper is available under the designation K13i15SG from NEENAH Gessner GmbH, Bruckmühl, Germany, and has a grammage of 235 g/m², a thickness of 0.55 mm, a porosity of 72%, an air permeability of 8 l/m²s and a resin content of 15 wt. %.

With this filter material, the initial separation efficiency for 4 μm particles according to ISO 19438, the dust storage capacity according to ISO 19438 and the water separation according to ISO 16332 were determined. The result is shown in Table 2.

### Example 2

### Invention

According to the generally known method for paper manufacturing, a paper web of 100% cellulose was generated in a paper machine. In a separate working step, this paper was impregnated with the same impregnating agent as in Example 1, with the only difference being that this time the impregnating agent was applied on only one side by roller application, namely to the wire side of the paper. After drying, the paper had a grammage of 221 g/m², a thickness of 0.49 mm, an air permeability of 9 l/m²s, a porosity of 70% and a resin content of 10%. The penetrating depth of the binder into the paper was 60% of the paper thickness. With this filter material, the initial separation efficiency for 4 μm particles according to ISO 19438, the dust storage capacity according to ISO 19438 and the water separation according to ISO 16332 were determined. The result is shown in Table 2.

TABLE 2

| | Example 1 | |
|---|---|---|
| | (Comparison) | Example 2 (Invention) |
| Initial separation efficiency | 98.10% | 98.00% |
| according to ISO 19348 | | |
| Dust storage capacity according | 0.64 g | 1.56 g |
| to ISO 19348 | | |
| Water separation according to | 13% | 44% |
| ISO 16332 | | |

1. A filter material, wherein the filter material is impregnated with a binder on only one side such that the opposite side is free of binder, the proportion of the dried binder being 0.5 to 50 wt. % of the total weight of the filter material.

2. The filter material according to claim 1, wherein the binder penetrates from the impregnated side of the filter material to the opposite side at least half and at the most three quarters of the thickness of the filter material.

3. The filter material according to claim 1, wherein the filter material comprises at least one material selected from the group consisting of wet-laid nonwovens, dry-laid nonwovens, fabrics and foams.

4. The filter material according to claim 1, wherein the filter material has a grammage of 50 g/m² to 400 g/m².

5. The filter material according to claim 1, wherein the filter material has a thickness of 0.1 mm to 2.0 mm.

6. The filter material according to claim 1, wherein the filter material has an air permeability of 1 l/m²s to 1500 l/m²s.

7. The filter material according to claim 1, wherein the filter material has a porosity of 50% to 90%.

8. The filter material according to claim 1, wherein on the non-impregnated side the filter material is connected to the wire side of a meltblown nonwoven.

9. The filter material according to claim 1, wherein on the impregnated side the filter material is connected to a meltblown nonwoven compressed by means of a calender.

10. A filter element comprising a filter material according to claim 1.

11. The filter material according to claim 1 for filtering liquids, wherein the liquid flows against the filter material from the non-impregnated side.

12. The filter material according to claim 11, wherein the liquid contains a solid material not soluble therein or the liquid contains two non-mixable liquids.

13. A method for separating two non-mixable liquids, wherein the liquids are conducted through a filter material according to claim 1 such that the liquids flow from the non-impregnated side to the impregnated side of the filter material.
